(19) United States
(12) Patent Application Publication
(10) Pub. No.: US 2011/0120411 A1
(43) Pub. Date: May 26, 2011

(54) SOLENOID CONTROL FOR VALVE ACTUATION IN ENGINE BRAKE

(75) Inventors: Ying Ren, Naperville, IL (US); Michale D. Bartkowicz, Oswego, IL (US); Qianfan Xin, Lake Zurich, IL (US); Martin R. Zielke, Lockport, IL (US); Luis Carlos Cattani, Aurora, IL (US)

(73) Assignee: International Engine Intellectual Property Company, LLC, Warrenville, IL (US)

(21) Appl. No.: 12/623,838

(22) Filed: Nov. 23, 2009

(51) Int. Cl. F02D 13/04; F01M 1/06

(52) U.S. Cl. 123/321; 123/90.33

(57) ABSTRACT

An apparatus and method for varying a counter force to valve spring preload of a brake exhaust valve to undertake engine braking, includes a solenoid controlled hydraulic actuator. A control cylinder is arranged to move with a rocker arm and a control piston is arranged to slide within the control cylinder. During engine braking the control piston slides to press the valve stem to open the brake exhaust valve. An oil chamber is arranged above the control piston and is open into the control cylinder. A source of pressurized oil is selectably introduced into the oil chamber by the solenoid controlled hydraulic actuator to slide the control piston within the control cylinder to open and hold open the brake exhaust valve.

### TECHNICAL FIELD

This disclosure relates to vehicles, particularly large tractor trailer trucks, including but not limited to control and operation of an engine for engine braking.

### BACKGROUND

Adequate and reliable braking for vehicles, particularly for large tractor-trailer trucks, is desirable. While drum or disc wheel brakes are capable of absorbing a large amount of energy over a short period of time, the absorbed energy is transformed into heat in the braking mechanism.

Braking systems are known which include exhaust brakes which inhibit the flow of exhaust gases through the exhaust system, and compression release systems wherein the energy required to compress the intake air during the compression stroke of the engine is dissipated by exhausting the compressed air through the exhaust system.

In order to achieve a high engine-braking action, a brake valve in the exhaust line may be closed during braking, and excess pressure is built up in the exhaust line upstream of the brake valve. For turbocharged engines, the built-up exhaust gas flows at high velocity into the turbine of the turbocharger and acts on the turbine rotor, whereupon the driven compressor increases pressure in the air intake duct. The cylinders are subjected to an increased charging pressure. In the exhaust system, an excess pressure develops between the cylinder outlet and the brake valve and counteracts the discharge of the air compressed in the cylinder into the exhaust tract via the exhaust valves. During braking, the piston performs compression work against the high excess pressure in the exhaust tract, with the result that a strong braking action is achieved.

Another engine braking method, as disclosed in U.S. Pat. No. 4,395,884, includes employing a turbocharged engine equipped with a double entry turbine and a compression release engine retarder in combination with a diverter valve. During engine braking, the diverter valve directs the flow of gas through one scroll of the divided volute of the turbine. When engine braking is employed, the turbine speed is increased, and the inlet manifold pressure is also increased, thereby increasing braking horsepower developed by the engine.

Other methods employ a variable geometry turbocharger (VGT). When engine braking is commanded, the variable geometry turbocharger is “clamped down” which means the turbine vanes are closed and used to generate both high exhaust manifold pressure and high turbine speeds and high turbocharger compressor speeds. Increasing the turbocharger compressor speed in turn increases the engine airflow and available engine brake power. The method disclosed in U.S. Pat. No. 6,594,996 includes controlling the geometry of the turbocharger turbine for engine braking as a function of engine speed and pressure (exhaust or intake, preferably exhaust).

U.S. Pat. No. 6,148,793 describes a brake control for an engine having a variable geometry turbocharger which is controllable to vary intake manifold pressure. The engine is operable in a braking mode using a turbocharger geometry actuator for varying turbocharger geometry, and using an exhaust valve actuator for opening an exhaust valve of the engine.

In compression-release engine brakes, there is an exhaust valve event for engine braking operation. For example, in the “Jake” brake, such as disclosed in U.S. Pat. Nos. 4,423,712; 4,485,780; 4,706,625 and 4,572,114, during braking, a braking exhaust valve is closed during the compression stroke to accumulate the air mass in engine cylinders and is then opened at a selected valve timing somewhere before the top-dead-center (TDC) to suddenly release the in-cylinder pressure to produce negative shaft power or retarding power.

In “Bleeder” brake systems, during engine braking, a braking exhaust valve is held constantly open during a large portion of the engine cycle to generate a compression-release effect.

According to the “EVBec” engine braking system of Man Nutzfahrzeuge AG, there is an exhaust secondary valve lift event induced by high exhaust manifold pressure pulses during intake stroke or compression stroke. The secondary lift profile is generated in each engine cycle and it can be designed to last long enough to pass TDC and high enough near TDC to generate the compression-release braking effect.

The EVBec engine brake does not require a mechanical braking cam or variable valve actuation (“VVA”) device to produce the exhaust valve braking lift events. The secondary valve lift is produced by closing an exhaust back pressure (“EBP”) valve located at the turbocharger turbine outlet and the exhaust valve held open by a “lock-in” hydraulic mechanism during the engine compression stroke. When the engine brake needs to be deactivated, the EBP valve is set back to its fully open position to reduce the exhaust manifold pressure pulses during each engine cycle so that the exhaust valve floating and secondary lift as well as the braking lift event at TDC do not occur. Such a system is described for example in U.S. Pat. No. 4,981,119.

When operating the EVBec engine brake, when the turbine outlet EBP valve is very closed, turbine pressure ratio becomes very low, hence engine air flow rate becomes low. Also, engine delta P (i.e., exhaust manifold pressure minus intake manifold pressure) and exhaust manifold pressure may become undesirably high. As a result, the compression-release effect can be weakened, retarding power can be reduced, and in-cylinder component (e.g. fuel injector tip) temperature can become undesirably high.

For the EVBec compression-release engine brake, the valve motion of the braking exhaust valve is determined passively by mainly the valve spring preload and exhaust manifold pressure pulses. The braking exhaust valve may open at an undesirable location (e.g., during the intake stroke), and it results in excessive gas leaking from the cylinder to intake manifold so that retarding power is reduced. Moreover, at low engine speed or when the turbine outlet exhaust back pressure (EBP) valve is opened, exhaust manifold pressure pulse is weaker (lower) than that at high speed or when the EBP valve is closed. In this situation, the braking valve is difficult to open due to the relatively strong spring preload and weak exhaust pressure pulse. For the purpose of increasing engine retarding power, it is desirable to open the EBP valve to increase turbine pressure ratio and engine air flow rate.

The present inventors recognize the desirability of producing a variable counter force to exhaust valve spring preload to control the braking valve motion and timing at variable speeds and exhaust manifold pressure levels.

The present inventors have recognized the desirability of providing a more effective engine braking system.

### SUMMARY

The exemplary embodiment of the invention provides an apparatus for varying a counter force to exhaust valve spring preload of a brake exhaust valve to undertake engine braking. The embodiment includes the brake exhaust valve having a first valve stem and a valve spring to urge the valve closed; a rocker arm for pressing the valve stem to open the valve by overcoming spring preload during engine firing operation; a control cylinder arranged to move with the rocker arm; a control piston arranged to slide within the control cylinder, during engine braking the control piston slidable to press the valve stem to open the valve; an oil chamber arranged above the control piston and open into the control cylinder; and a source of pressurized oil selectably introduced into the oil chamber to slide the control piston within the control cylinder.

The component for selectively introducing pressurized oil can be a solenoid valve arranged to selectively open the oil chamber to the source of pressurized oil. Alternately, a first passage can be arranged between the source of pressurized oil and the oil chamber and a second passage can be arranged between the oil chamber and the crankcase and a solenoid valve can be arranged in the second passage to close in order to subject the oil chamber to the source of pressurized oil.

More particularly, the embodiment can include a valve bridge and a further exhaust valve having a second valve stem, the valve bridge arranged between the rocker arm and the first and second valve stems of the brake exhaust valve and the further exhaust valve. The valve bridge is movable with the rocker arm to open the brake exhaust valve and the further exhaust valve. The control cylinder can be formed into the valve bridge.

The source of pressurized oil can be oil pressurized by the engine oil circulation pump taken from the oil passage at the rocker arm shaft. The source of pressurized oil can also be a booster oil pump taking suction from engine oil pre-pressurized by the engine oil circulation pump, which delivers a higher oil pressure and can change the equivalent net spring load more significantly.

An exemplary method of the invention includes the steps of:

generating a source of pressurized oil; and

during engine braking, using the source of pressurized oil to selectively press the first valve stem to overcome spring preload to open the brake exhaust valve.

More particularly, the method is further defined by arranging a control cylinder to move with the rocker arm, and a control piston arranged to slide within the control cylinder, the control piston operable to press the valve stem to open the valve, and an oil chamber arranged above the control piston and open into the control cylinder; and

selectably introducing pressurized oil into the oil chamber to slide the control piston within the control cylinder.

Furthermore, the step of selectively introducing pressurized oil can be further defined in that pressurized oil flowing though the oil chamber and into the crankcase is shut off downstream of the oil chamber, allowing the oil chamber to reach the elevated pressure of the source of pressurized oil.

Alternately, the step of selectively introducing pressurized oil can be further defined in that the source of pressurized oil is first closed from the oil chamber is then opened to the oil chamber to reach the pressure of the source of pressurized oil.

The exemplary apparatus and methods of the invention use solenoid valves and electro-hydraulic actuation designs to dynamically effect a counter force to exhaust valve spring preload. The electro-hydraulic actuation may occur once or multiple times during the engine cycle. When it occurs once during an engine cycle, it may produce a constant force acting on the braking valve. When it occurs multiple times, it may modulate to produce variable forces with certain higher resolution at the crank angle level.

The exemplary apparatus and methods of the invention use an electro-hydraulic design to vary the net force acting on the exhaust braking valve(s) in compression-release engine brakes to control the braking valve timing and motion according to the needs at different engine speeds and levels of exhaust manifold pressure pulses. In addition, it reduces the need for high back pressure build up. As a result, engine retarding power can be increased.

Engine retarding power may be increased through better braking motion control due to three reasons: less leakage of cylinder flow into the intake manifold; and more exhaust mass or energy can be harvested into the cylinder from the exhaust manifold to be further compressed by the engine piston motion to even hotter at the braking TDC (i.e., transferring more energy fed to the turbine); and more airflow mass from the intake manifold into the cylinder due to improved turbocharger efficiency from reduced back pressure. At low speed, it is possible to open the braking exhaust valve to activate the EVBec engine brake under a reduced net opening force across the valve.

Numerous other advantages and features of the present invention will become readily apparent from the following detailed description of the invention and the embodiments thereof, from the claims and from the accompanying drawings.

### BRIEF DESCRIPTION OF THE DRAWINGS

FIG. 1 is a schematic diagram of an engine braking system according to an exemplary apparatus of the invention;

FIG. 2 is a schematic side view of an exhaust valve system according to an exemplary apparatus of the invention;

FIG. 3 is an enlarged fragmentary sectional view of a portion of a first embodiment of the exemplary apparatus shown in FIG. 2, as taken from FIG. 4B;

FIG. 4A is a fragmentary sectional view of an engine incorporating the exemplary apparatus shown in FIG. 3, shown in an “on” engine brake state;

FIG. 4B is a fragmentary sectional view of an engine incorporating the exemplary apparatus shown in FIG. 3, shown in an “off” engine brake state;

FIG. 5 is an enlarged fragmentary sectional view of a portion of a second embodiment of the exemplary apparatus shown in FIG. 2, as taken from FIG. 6A;

FIG. 6A is a fragmentary sectional view of an engine incorporating the exemplary apparatus shown in FIG. 5, shown in an “on” engine brake state; and

FIG. 6B is a fragmentary sectional view of an engine incorporating the exemplary apparatus shown in FIG. 5, shown in an “off” engine brake state.

### DETAILED DESCRIPTION

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

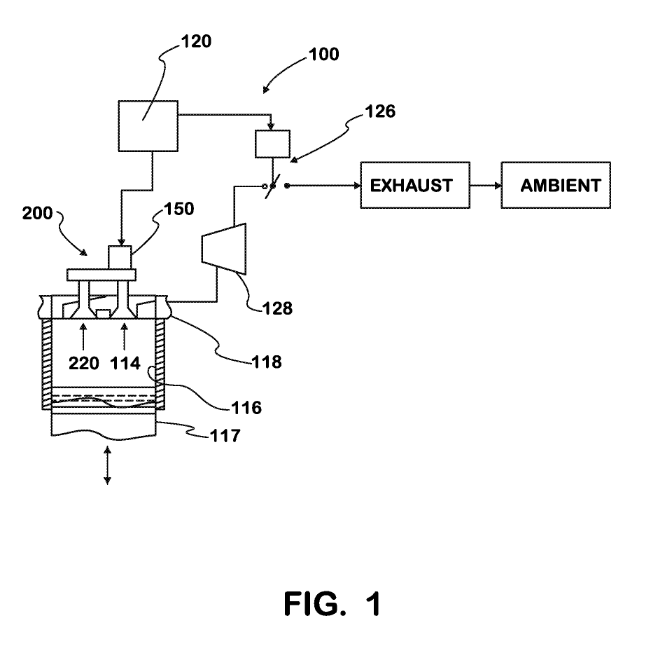

FIG. 1 illustrates a simplified schematic of an engine braking control system 100. The system acts on an exhaust valve 114 that opens a cylinder 116 to an exhaust manifold 118. A piston 117, operatively connected to an engine crankshaft (not shown), reciprocates within the cylinder 116. An engine braking electronic control is signal-connected to a downstream EBP valve 126 which, by closing, can increase backpressure through a turbocharger turbine 128 and back through the exhaust gas manifold 118. Although the EBP valve 126 is shown downstream of the turbine 128, it is poossible that the EBP valve could be located upstream of the turbine 128. The control is also signal-connected to a counter-preload device 150 to allow the exhaust valve 114 to be opened by differential pressure between the exhaust manifold 118 and pressure within the cylinder 116. The control 120 can initiate exhaust-manifold-pressure-pulse-induced valve motion by commanding the EBP valve 128 to close to a specified degree and also increasing the counter-preload force on the valve 114 by commanding an increase in counter-preload force by the device 150.

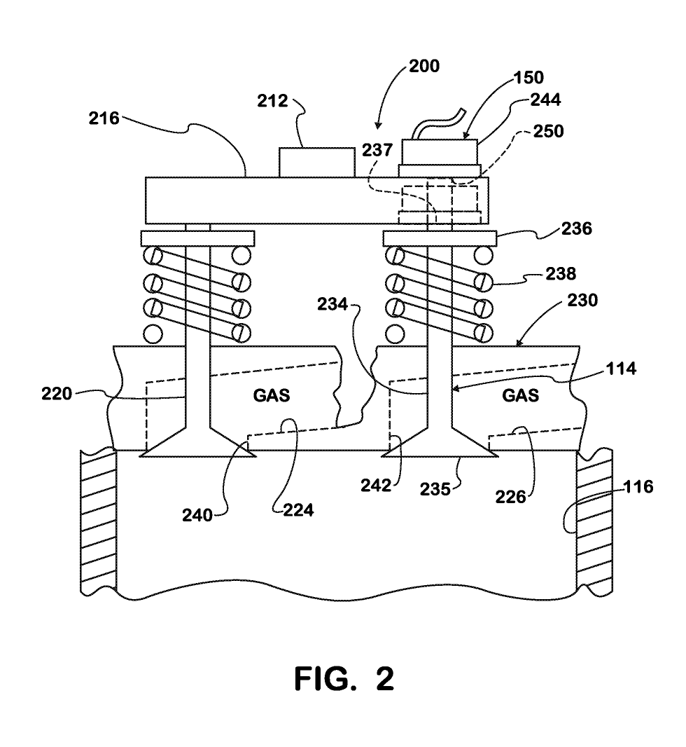

FIG. 2 shows a counter-preload device (either on/off type or variable type) for achieving an ultra-low required opening force across a spring loaded exhaust valve used in the engine brake with exhaust-manifold-pressure-pulse-induced valve motion. The device reduces the required opening force across a valve by countering the valve spring preload to enable high retarding power at very low engine speed because with very low required opening force, the exhaust braking valve may float easily to generate a high secondary valve lift to recover more exhaust gas mass from exhaust manifold to cylinder to enable the high-temperature-flow operation of the engine brake through a faster spinning turbine. The variable counter-preload device can also adjust retarding power continously by regulating the size of exhaust secondary valve lift event. Moreover, the variable counter-preload device, if designed with electro-magnetic means, may be used to totally or partially deactivate the engine brake by applying an attractive magnetic force on the top of the braking valve to increase the closing force on the valve to stop the secondary lift event.

FIG. 2 shows an exemplary preload system 200 for ultra-low required valve opening force, either an on/off type or variable type, used in engine braking operation. Identical devices can be used at all cylinders or some of the cylinders, of the engine, although only the system 200 at the cylinder 116 is shown. The system 200 includes a rocker arm 212, a valve bridge 216, the counter-preload device 150, a normally operated exhaust valve 220 and an braking exhaust valve 114. The valves 220 and 114 open the cylinder 116 to the exhaust manifold via exhaust gas passages 224, 226 provided in a cylinder head 230.

Each valve includes a stem 234 having a stem end 237, a head 235, and a spring keeper 236. A valve spring 238 surrounds the stem 234 and is fit between the keeper 236 and the cylinder head 230. To move the heads 235 away from valve seats 240, 242 during normal engine operation, at the selected crankshaft angle, the rocker arm 212 presses the valve bridge 216 down to move the valve stems 234 down via force on the ends 237 against the expansion force of the springs 238 as the springs are being compressed between the keepers 236 and the cylinder head 230, and against the cylinder pressure force on the valve.

During an engine braking operation, differential pressure across the head 235 of the valve 114 moves the head 235 down and away from the valve seat 242 and exhaust gas can enter the cylinder 116. In this regard the valve is a “floating exhaust valve” in that differential pressure across the valve is sufficient to push the valve downward away from its seat. The differential pressure force is due to the pressure difference between exhaust gas backpressure within the passage 226 and the pressure within the cylinder 116. The differential pressure must also be sufficient to overcome the expansion force of the spring 238 as the opening of the valve 114 compresses the spring 238.

The counter-preload device 150 includes an actuator portion 244 shown installed on top of the valve bridge 216. Alternatively, the actuator portion 244 can be installed within the valve bridge (shown dashed). The device 150 also includes a rod 250. The rod 250 is moved by force from the actuator portion 244 to press down the end 237 of the stem. The required opening force across the valve refers to the net force on the valve of the normal spring preload and the opposing force exerted by the counter-preload device. The counter-preload device 150 can provide engine brake activation and deactivation controls and the ability of achieving variable required opening force across the valve to obtain variable or higher retarding power during engine braking operation. The device 150 can be variable or can be strictly on/off.

The device may reduce the required opening force across the valve to enable the brake to operate at very low engine speed because with very low required opening force across the valve the exhaust braking valve may float easily off its valve seat to generate a secondary valve lift for braking. Moreover, the device can make the secondary lift very high to recover more exhaust gas mass from exhaust manifold to cylinder to enable the high-flow-temperature operation of the engine brake through a faster spinning turbine.

Alternately, the rod 250 can be operatively connected to the valve stem 234 so that the actuator can exert a selectable two way force (up or down) on the valve 114. In this way the device 150 can act to assist the spring 238 in closing the valve in addition to acting as a counter-preload to open the valve. It is also possible that the device, configured as a two way force acting device, can eliminte the need for the spring altogether.

The variable counter-preload device can also adjust retarding power continously by regulating the size of exhaust secondary valve lift event.

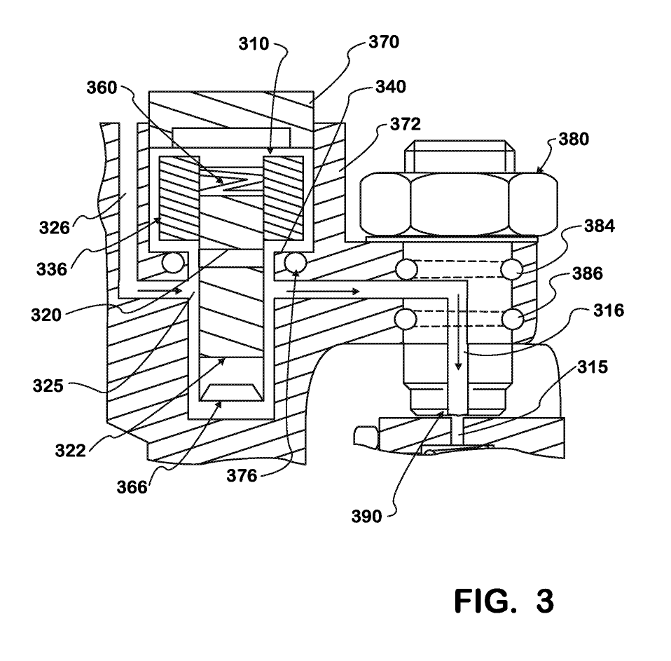

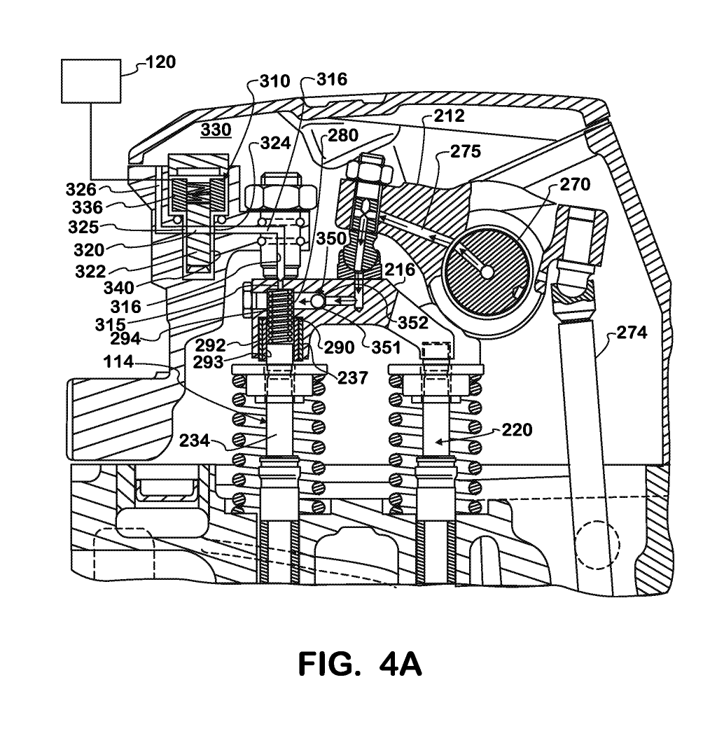

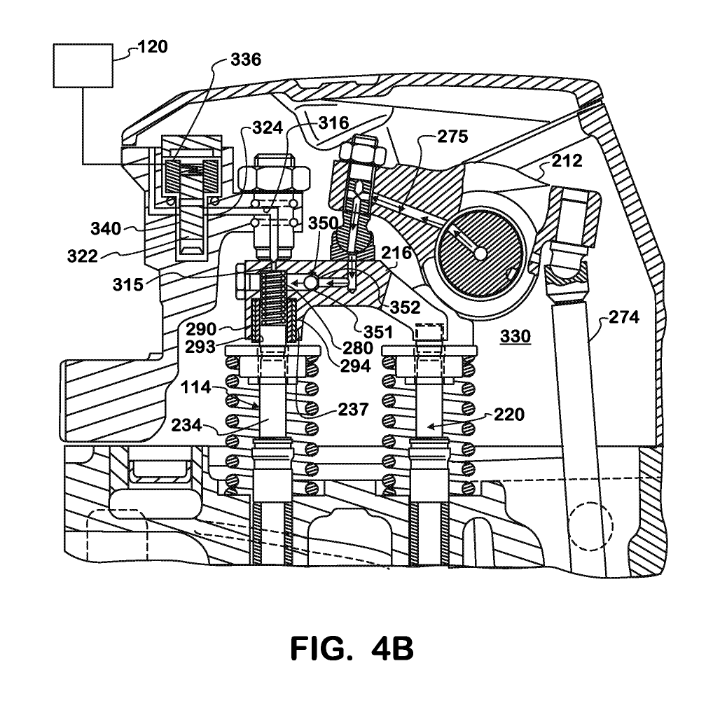

FIGS. 3-4B illustrates one embodiment of the invention. Referring to FIG. 4A, a rocker arm shaft 270 pivotally supports a plurality of rocker arms 212 (one shown). The rocker arms 212 pivot about the shaft 270 by reciprocating vertical movement of push rods 274 which are moved by a camshaft (not shown). In this configuration, oil is supplied through an oil passage 275 from the existing engine pressurized oil supply in the rocker arm shaft 270, through the rocker arm 212, through the valve bridge 216 and to an oil chamber 280 above a control piston 290 overlying the valve 114. The control piston 290 is sealingly slidable within a control cylinder 292 formed in the valve bridge 216.

An end portion of the valve stem 234, including the valve stem end 237, fits within a socket portion 293 of the piston 290. A spring 294 braced against the valve bridge 216 and the piston 290 maintains a pressing contact between the piston 290 and the valve stem end 237.

A solenoid valve 310 is normally open (FIG. 4A). The oil from the rocker arm shaft 270 and in the oil chamber 280 bleeds out through a channel 315, through a channel 316, through a valve passage 320 in a valve element 322 of the solenoid valve 310 that is in registry with side holes 324, 325 in a surrounding body 340 of the solenoid valve 310, and through a channel 326 into the crankcase 330. The hydraulic force acting down upon the top of the valve 114, via the piston 290 is insignificant.

As shown in FIGS. 3 and 4B, when a solenoid coil 336 of the solenoid valve 310 is energized, the solenoid valve element 322 is raised by magnetic force and the valve passage 320 is closed with respect to the surrounding body 340 of the solenoid valve 310. The oil pressure in the channels 316, 315, in the oil chamber 280, and in the passage 275 is raised to that of the oil pressure in the rocker arm shaft 270. The elevated oil pressure in the oil chamber 280 acting on the piston 290 generates a step-change hydraulic force acting on the end 237 of the valve 114 and pushes the valve 114 downward and open. The amplitude of the hydraulic force is determined by the oil supply pressure and the area of the piston 290 at the top of the valve.

During the compression stroke, when the air pressure within the cylinder 116 increases as the piston 117 (FIG. 1) moves up, the pressure inside the oil chamber 280 pushes closed a check valve 350, represented as a ball check valve, to reverse flow into the oil supply from the passage 275. A ball 351 closed against a seat 352 effectively seals an inlet side of the oil chamber 280. The valve 114 is therefore locked in the open position.

The oil in the chamber 280 is eventually released during the exhaust stroke when the valve bridge 216 is pushed down by cam on the camshaft (not shown) via the pushrod 274 and the rocker arm 212, and opens the channel 315 on top of the oil chamber 280 to the crankcase 330.

The operation of the solenoid valve 310 is controlled by control 120 which can be controlled by, or be part of, the electronic control unit (ECU) of the engine. This configuration requires no additional oil pump.

To return the solenoid valve element 322 to the original position, the solenoid coil 310 is de-energized. A return spring 360 between a top of the element 322 and the body 340 forces the solenoid valve element 322 back to the original position with the passage 320 open with respect to side holes 324, 325 in the body 340. Alternatively, another close solenoid may be mounted on the opposite side of the solenoid coil 336 to pull the valve element 322 to the original position. A seating spring 366 between the element 322 and a bottom surface of the body 340 reduces the amplitude of the impact noise.

A cover 370 can be applied over the body 340 to retain the body into a wall 372 of the crankcase 330. The cover 370 and/or the body 340 can have external threads to be threaded into internal threads in the wall 372 to retain the body into the wall 372. An o-ring seal 376 can be applied between the body 340 and the wall 372.

The channel 316 can be formed through a fitting 380 having external threads that can engage inside threads of the wall 372. A pair of o-ring seals 384, 386 seal the channel 316 between the fitting 380 and the wall 372. An end surface 390 of the fitting 380 forms a seat between the fitting 380 and the bridge 216, to form a substantially sealed connection between the channel 316 and the channel 315.

The solenoid valve 310 may include one coil, one preloaded spring, one seating spring, and one moving piston; or one actuation coil, one returning coil, one moving piston (not shown), or the like.

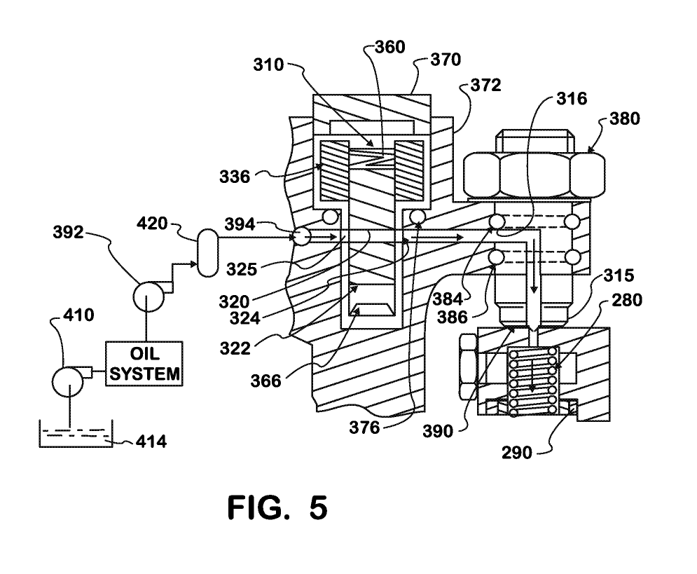

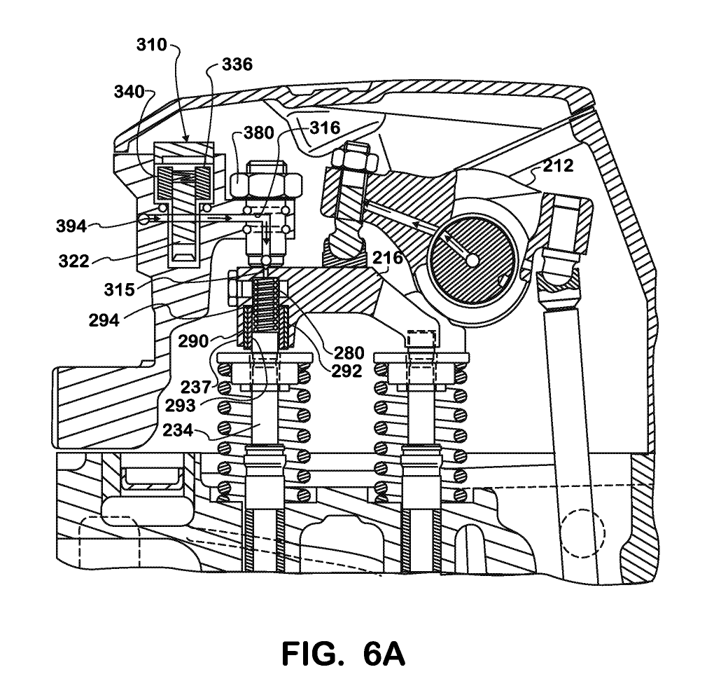

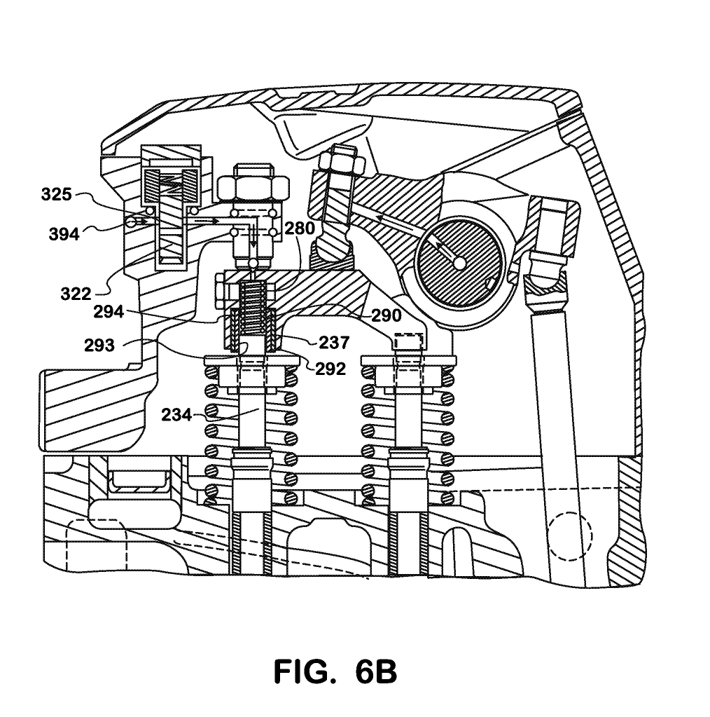

FIGS. 5-6B illustrate another embodiment of the invention. In this configuration, oil under higher pressure is supplied from a booster oil pump 392 (shown schematically) to a passage 394. The booster pump can take suction from pressurized oil from the engine oil circulation pump and raises the oil pressure further. The solenoid valve 310 is normally in the closed position (FIG. 6B). The passage 394 at the hole 325 is blocked by the element 322. The hydraulic force acting upon the top of the valve 114 via the control piston 290 is insignificant.

When the solenoid valve 310 is energized, the solenoid valve element 322 is pulled up by the coil 336 and the passage 320 registers with the holes 324, 325 in the surrounding body 340 (FIGS. 5 and 6A). The passage 394 is connected with the passage 320 and the channel 316 that passes through the wall 372 and through the fitting 380. The channel 316 is connected to the channel 315 and to the oil chamber 280 on top of the control piston 290. Oil pressure builds up in the oil chamber 280, which generates a step-change hydraulic force acting on top of the valve 114, via the control piston 290, and pushes the valve 114 open. The amplitude of the hydraulic force is determined by the oil supply pressure and the area of the control piston 290 at the top of the valve 114.

The solenoid valve 310 is then closed by the coil 336 lowering the element 322, which locks in the oil in the oil chamber 280 and effectively seals the chamber 280, and the valve 114 is locked in the open position.

The oil in the chamber 280 is released at the exhaust stroke when the valve bridge 216 is pushed down by the cam and opens the hole on top of the oil chamber.

The solenoid valve operation can be controlled by, or be part of, the ECU of the engine. This configuration may use an accumulator 420 which receives pressurized oil from the pump 392. The oil pressure delivered from the booster oil pump can be made higher than the oil pressure from the rocker arm shaft (FIG. 4A), and a greater step change hydraulic force can be generated. The booster pump 392 takes suction from the oil lubrication system that is elevated in pressure by the engine oil circulation pump 410 taking suction from the oil sump 414 of the engine (shown schematically in FIG. 5). This elevated oil pressure allows the valve 114 to open more swiftly, which leads to more precise control of the valve 114.

The solenoid valve 310 may include one coil 336, one preloaded spring 360, one seating spring 366, and one moving valve element; or one actuation coil 336, one returning coil (not shown), one moving valve element 322, or the like.

When the actuation solenoid coil is energized, it pulls the moving valve element towards the coil, and opens the valve 310. To return the element 322 to the original position, the actuation solenoid coil is de-energized. The spring 360 forces the element 322 back to the original position. Alternatively, another close solenoid may be mounted on the opposite side of the solenoid coil 336 to pull the valve element 322 to the original position. The seating spring 366 reduces the amplitude of the impact noise.

From the foregoing, it will be observed that numerous variations and modifications may be effected without departing from the spirit and scope of the invention. It is to be understood that no limitation with respect to the specific apparatus illustrated herein is intended or should be inferred.

The invention claimed is:

1. An apparatus for varying required opening force across the valve of a brake exhaust valve to undertake engine braking in an engine having an engine piston reciprocating in an engine cylinder, the exhaust valve opening the engine cylinder to an exhaust system, and an engine oil circulation pump, comprising:
the brake exhaust valve having a first valve stem and a valve spring to urge the valve closed;
a rocker arm for pressing the valve stem to open the valve by overcoming spring preload during engine firing operation;
a control cylinder arranged to move with the rocker arm;
a control piston arranged to slide within the control cylinder, during engine braking the control piston slidable to press the valve stem to open the valve;
an oil chamber arranged above the control piston and open into the control cylinder; and
a source of pressurized oil selectably introduced into the oil chamber to slide the control piston within the control cylinder.

2. The apparatus according to claim 1, comprising a valve bridge and a further exhaust valve having a second valve stem, the valve bridge arranged between the rocker arm and the first and second valve stems of the brake exhaust valve and the further exhaust valve, the valve bridge movable with the rocker arm to open the brake exhaust valve and the further exhaust valve, the control cylinder being formed into the valve bridge.

3. The apparatus according to claim 2, wherein the source of pressurized oil comprises an oil pump taking suction from engine oil pressurized by the engine oil circulation pump.

4. The apparatus according to claim 2, wherein the source of pressurized oil comprises oil pressurized by the engine oil circulation pump.

5. The apparatus according to claim 1, wherein the source of pressurized oil comprises an oil pump taking suction from engine oil pressurized by the engine oil circulation pump.

6. The apparatus according to claim 1, wherein the source of pressurized oil comprises oil pressurized by the engine oil circulation pump.

7. The apparatus according to claim 1, comprising a solenoid valve arranged to selectively open the oil chamber to the source of pressurized oil.

8. The apparatus according to claim 1, comprising a first passage between the source of pressurized oil and the oil chamber and a second passage between the oil chamber and the crankcase and a solenoid valve arranged in the second passage to close in order to subject the oil chamber to the source of pressurized oil.

9. The apparatus according to claim 8, comprising a check valve arranged in the first passage.

10. A method of varying required opening force across the valve of a brake exhaust valve to undertake engine braking, the brake exhaust valve having a first valve stem and a valve spring to urge the valve closed with a spring preload, comprising the steps of:
generating a source of pressurized oil; and
during engine braking, using the source of pressurized oil to selectively press the first valve stem to overcome spring preload to open the brake exhaust valve.

11. The method according to claim 10, wherein the engine comprises a rocker arm for pressing the valve stem to open the valve by overcoming spring preload during firing operation of the engine, wherein the step of selectively pressing the first valve stem to overcome spring preload to open the brake exhaust valve is further defined by arranging a control cylinder to move with the rocker arm, and a control piston arranged to slide within the control cylinder, the control piston operable to press the valve stem to open the valve, and an oil chamber arranged above the control piston and open into the control cylinder; and
selectably introducing pressurized oil into the oil chamber to slide the control piston within the control cylinder.

12. The method according to claim 11, wherein the step of selectively introducing pressurized oil is further defined in that pressurized oil flowing though the oil chamber and into the crankcase is shut off downstream of the oil chamber, allowing the oil chamber to reach the elevated pressure of the source of pressurized oil.

13. The method according to claim 11, wherein the step of selectively introducing pressurized oil is further defined in that the source of pressurized oil is first closed from the oil chamber is then opened to the oil chamber to reach the pressure of the source of pressurized oil.

14. The method according to claim 10, comprising the further step of using a hydraulic lock-in mechanism to keep the brake exhaust valve open during a compression stroke.
